(19) United States
(12) Patent Application Publication
(10) Pub. No.: US 2005/0191444 A1
(43) Pub. Date: Sep. 1, 2005

(54) Inkjet recording media with a fusible bead layer on a porous substrate and method

(75) Inventors: Bruce C. Campbell, Webster, NY (US); Lisa B. Todd, Rochester, NY (US); Gregory E. Missell, Penfield, NY (US); Lawrence P. DeMejo, Rochester, NY (US); Allan Wexler, Pittsford, NY (US); James A. Reczek, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/787,511

(22) Filed: Feb. 26, 2004

(51) Int. Cl. B41M 5/00

(52) U.S. Cl. 428/32.34

(57) ABSTRACT

An inkjet recording element having a porous support having thereon a fusible, porous ink-receptive layer of fusible polymeric particles. The invention is also directed to an inkjet printing process wherein the ink-receptive layer and/or the support in combination is capable of receiving substantially all of the ink-carrier liquid received by the inkjet recording element.

### FIELD OF THE INVENTION

This invention relates to an inkjet recording element. More particularly, this invention relates to an inkjet recording element comprising a porous substrate with a fusible thermoplastic bead layer on top.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water and organic materials such as a monohydric alcohol, a polyhydric alcohol, or mixtures thereof.

An inkjet recording element typically comprises a support having on at least one surface thereof an ink-receptive or image-receiving layer and includes those intended for reflection viewing, which have an opaque support, and those intended for viewing by transmitted light, which have a transparent support.

A desirable characteristic of inkjet recording elements is the capability to dry quickly after printing. To this end, porous recording elements have been developed which provide nearly instantaneous drying as long as they have sufficient thickness and pore volume to effectively contain the liquid ink. For example, a porous recording element can be manufactured by cast coating, in which a particulate-containing coating is applied to a support and is dried in contact with a polished smooth surface.

Inkjet prints, prepared by printing onto inkjet recording elements, are potentially subject to environmental degradation. They are especially vulnerable to damage resulting from contact with water and atmospheric gases such as ozone. The damage resulting from post-imaging contact with water can take the form of water spots resulting from deglossing of the top coat, dye smearing due to unwanted dye diffusion, and even gross dissolution of the image recording layer. Ozone bleaches inkjet dyes resulting in loss of density.

To overcome these deficiencies inkjet prints are often laminated. However, lamination is expensive since it requires a separate roll of material. Print protection can also be provided by coating a polymer solution or dispersion onto the surface of an inkjet element after the image is formed. The aqueous coating solutions are often polymer dispersions capable of film formation when water is removed. However, due to the wide variety of surface properties, it is difficult to formulate an aqueous polymer solution to be universally compatible to all inkjet receivers.

Numerous publications teach the concept of fusible organic particles as an overcoat layer of an inkjet recording media in order to achieve fast ink absorption before fusing and image protection after fusing.

Alternatively, inkjet recording elements have a two-layer construction; such as described in European Patent Application Publication No. 1078775 A2, Japanese Patent No. 59222381 and U.S. Pat. No. 4,832,984 have been employed. These elements typically have a porous ink transporting topcoat of thermally fusible particles residing on either a swellable or porous ink-retaining layer. Upon printing, the ink passes through the topcoat and into an ink-retaining layer. The topcoat layer is then sealed to afford a water and stain resistant print. Such topcoats containing thermally fusible particles typically either contain a binder or are thermally sintered to provide a level of mechanical integrity to the layer prior to the imaging and fusing steps. In all cases, the topcoat layer and ink-retaining layer must be coated on a substrate at sufficient thicknesses and pore volumes to contain the liquid ink.

U.S. Pat. No. 6,550,909 describes an inkjet recording method using a pigmented ink and a recording medium comprising a substrate and a top porous layer formed from thermoplastic resin particles and an intermediate porous layer between the top layer and substrate of inorganic particles. As mentioned above, the topcoat and intermediate layer must be sufficiently thick to contain the printed liquid ink. Coating these thick, porous layers can be difficult from a manufacturing standpoint and can be costly.

The commonly assigned, co-pending U.S. patent application Ser. No. 10/289,607 filed Nov. 07, 2002 by Yau et al., titled “Inkjet Printing Method” and U.S. patent application Ser. No. 10/289,862 filed Nov. 07, 2002 by Yau et al., titled “Inkjet Recording Element,” both hereby incorporated by reference in their entirety, describe an inkjet recording element comprising a support having a porous image receiving layer with at least two types of hydrophobic polymer particles. Again, the porous image-receiving layer must be sufficiently thick to contain the printed liquid ink. In particular, Yau et al. teach the use of high Tg monodisperse particles in combination with a low Tg hydrophobic binder in an ink-receptive layer to provide an inkjet media exhibiting rapid ink absorption. Fusing of such printed media converts the ink-receptive layer to a transparent water-resistant and stain-resistant layer. The actual examples in Yau et al. employed polyethylene-coated paper, although paper and void-containing polyolefins, polyesters, and members are listed as possible supports.

It is an object of this invention to provide a novel porous inkjet recording element that absorbs inks instantly, and after imaging, provides an image which has good quality and is water and abrasion resistant

### SUMMARY OF THE INVENTION

These and other objects are achieved in accordance with the invention which comprises an inkjet recording element comprising one layer above a porous support that comprises a fusible, porous ink-receptive layer comprising fusible polymeric particles, wherein the porous support comprises interconnecting open-cell pores facing and immediately adjacent to the ink-receptive layer and therefore capable of receiving a substantial amount of ink carrier liquid from the fusible, porous ink-receptive layer.

In a preferred embodiment of the invention, the inkjet-receiving element comprises a porous support with interconnecting voids having a Bristow absorption value of at least about 3 ml/m².

By use of the invention, a porous inkjet recording element is obtained that, when printed with an inkjet ink, is essentially “instant” dry to the touch and has good gloss and water resistance after fusing. Due to the porous, open-cell nature of the substrate, the thickness of the fusible image-receiving layer can be minimized since the substrate can assist in containing the printed liquid ink. Furthermore, an imaged inkjet recording element is obtained that has good abrasion resistance, and which when printed with an inkjet ink, and subsequently fused, has good water-resistance and high print density.

The invention is also directed to an inkjet printing process, comprising the steps of:
A) providing an inkjet printer that is responsive to digital data signals;
B) loading the inkjet printer with the inkjet recording element of claim 1, the inkjet recording element comprising a fusible, porous ink-receptive layer comprising fusible, polymeric particles;
C) loading the inkjet printer with an inkjet ink composition;
D) printing on the inkjet recording element using the inkjet ink composition in response to the digital data signals; and
E) fusing the ink-receptive layer.

The term “uppermost” or “upper” as used herein refers to that side, or towards the side, of the inkjet recording element intended for application of the ink composition, i.e. the side of the element pre-designed for receiving the applied image. Similarly, the term “bottom” or back” as used herein refers to the opposite side, or towards the opposite side, of the inkjet recording element.

### DETAILED DESCRIPTION OF THE INVENTION

The fusible, porous ink-receptive layer (also referred to as the image-receiving layer) receives the ink, i.e. fluid and colorant and retains substantially all the colorant, especially pigmented colorants. Upon fusing, via the application of heat and/or pressure, the air particle interfaces present in the original porous structure of the layer are eliminated, and a non-scattering substantially continuous layer forms which contains the image. It is an important feature of the invention that the ink-receptive layer is fusible into a non-scattering layer, as this significantly raises image density.

The fusible, polymeric particles employed in the fusible, porous ink-receptive layer of the invention ranges from about 0.1 μm to 10 μm. The particles employed in the fusible, porous ink-receptive layer may be formed from any polymer which is fusible, i.e., capable of being converted from discrete particles into a substantially continuous layer through the application of heat and/or pressure. In a preferred embodiment of the invention, the fusible, polymeric particles comprise a condensation polymer, a styrenic polymer, a vinyl polymer, an ethylene-vinyl chloride copolymer, a polyacrylate, poly(vinyl acetate), poly(vinylidene chloride), a vinyl acetate-vinyl chloride copolymer, and acid esters of cellulose. In still another preferred embodiment, the condensation polymer may be a polyester or polyurethane.

A binder may be employed in the fusible, porous ink-receptive layer. Such a binder can comprise any film-forming polymer that serves to bind together the fusible polymeric particles. In a preferred embodiment of the invention, the binder is a hydrophobic film forming binder derived from an aqueous dispersion of an acrylic polymer or a polyurethane.

Optionally, a dye mordant can be employed in the fusible, porous ink-receptive layer. The dye mordant can be any material which is substantive to inkjet dyes. The dye mordant fixes the dye within the porous fusible ink-receptive layer. This is especially desirable if a porous support, described below, which is capable of further absorption of the ink carrier liquid underlies the fusible porous ink-receptive layer. Examples of such mordants include cationic lattices such as disclosed in U.S. Pat. No. 6,297,296 and references cited therein, cationic polymers such as disclosed in U.S. Pat. No. 5,342,688, and multivalent ions as disclosed in U.S. Pat. No. 5,916,673, the disclosures of which are hereby incorporated by reference. Examples of these mordants include polymeric quaternary ammonium compounds, or basic polymers, such as poly(dimethylaminoethyl)-methacrylate, polyalkylenepolyamines, and products of the condensation thereof with dicyanodiamide, amine-epichlorohydrin polycondensates. Further, lecithins and phospholipid compounds can also be used. Specific examples of such mordants include the following: vinylbenzyl trimethyl ammonium chloride/ethylene glycol dimethacrylate; poly(diallyl dimethyl ammonium chloride); poly(2-N,N,N-trimethylammonium)ethyl methacrylate methosulfate; poly(3-N,N,N-trimethyl-ammonium)propyl methacrylate chloride; a copolymer of vinylpyrrolidinone and vinyl(N-methylimidazolium chloride; and hydroxyethylcellulose derivatized with 3-N,N,N-trimethylammonium)propyl chloride. In a preferred embodiment, the cationic mordant is a quaternary ammonium compound.

In order to be compatible with the mordant, both the binder and the polymer comprising the fusible particles should be either uncharged or the same charge as the mordant. Colloidal instability and unwanted aggregation would result if the polymer particles or the binder had a charge opposite from that of the mordant.

In one preferred embodiment of the invention, the fusible particles in the fusible, porous ink-receptive layer may range from about 95 to about 60 parts by weight, the binder may range from about 40 to about 5 parts by weight, and the dye mordant may range from about 2 parts to about 40 parts by weight. Most preferred is 80 parts by weight fusible particles, 10 parts by weight binder, and 10 parts by weight dye mordant when a dye ink is used. A mordant may not be necessary if a pigment ink is used.

The fusible, porous ink-receptive layer is present in an amount from about 1 g/m² to about 60 g/m². In a preferred embodiment, the ink-receptive layer is present in an amount from about 3 g/m² to about 30 g/m².

In the preferred embodiment, the support has a Bristow Test absorption value of least 3 ml/m², preferably at least 6 ml/m², more preferably 6 to 100 ml/m². Preferably, the porous support and the fusible, porous ink-receptive layer in combination have a Bristow Test absorption value of at least 10 ml/m², preferably 20 ml/m² to 120 ml/m². Bristow Test absorption values are measured as described herein. The Bristow Test is one that measures the amount of test fluid absorbed into a receiver element under specified test conditions. This test is described fully in test method ASTM D 5455 “Short-Term Liquid Sorption Into Paper (Bristow Test).”

However, the desired absorption is related to the amount of fluid applied which amount may vary depending on the printer and the ink composition employed.

In order to impart mechanical durability to an inkjet recording element, crosslinkers which act upon a binder may be added in small quantities to the ink-receptive layer. Such an additive improves the cohesive strength of the layer. Crosslinkers such as carbodiimides, polyfunctional aziridines, aldehydes, isocyanates, epoxides, oxazolines, amines, polyvalent metal cations, vinyl sulfones, pyridinium, pyridylium dication ether, methoxyalkyl melamines, triazines, dioxane derivatives, chrom alum, zirconium sulfate, and the like may be used. Preferably, the crosslinker is an aldehyde, an acetal, or a ketal, such as 2,3-dihydroxy-1,4-dioxane.

The support used in the inkjet recording element of the invention must be porous with interconnecting voids, at least adjacent the image-receiving layer. Typically, the support by itself is a self-standing material for providing sufficient structural rigidity. Typically, the image-receiving layer by itself is not a self-standing material, but is supported by the porous support. The support must provide sufficient rigidity for the media, typically at least 15 milliNewtons as measured by the L&W 10-1 Stiffness Tester (Lorentzen and Wettre Co.) using the SCAN-p29 (Scandinavian Pulp, Paper and Board) method.

As used herein, the term “support” or “porous support,” with respect to the inkjet recording element, is an integral material that supports the image-receiving layer and includes the bottom surface of the inkjet recording element. The support either comprises a single layer or, if comprising more than one layer, comprises either (1) an adjacent layer that comprises at least 80% of the thickness of the element and/or (2) an adjacent layer that is either paper or a voided extruded polymeric film that is extruded, including optional co-extrusion with additional underlying layers in the support, wherein the adjacent layer forms the upper surface of the support and is the porous layer contiguous or in contact with the image-receiving layer. Preferably, if the upper layer is coextruded, the coextruded portion also comprises at least 80%, preferably at least 90% of the thickness of the element. There may be used, for example, such porous supports as cellulosic papers, open-pore polyolefins, open-pore polyesters, or an open pore membrane. In the preferred embodiment, the ink-receptive layer is coated on the porous support.

In one embodiment of the present invention a porous polyester support such as disclosed in U.S. Pat. No. 6,379,780 to Laney et al. and U.S. Pat. No. 6,489,008, the disclosures of both of which is hereby incorporated by reference, can be used. This polyester support comprises a base polyester layer and an ink-liquid-carrier permeable upper polyester layer, the upper polyester layer comprising a continuous polyester phase having a total absorbent capacity of at least about 14 ml/m² but which absorbent capacity can be adjusted as desired for use in the present invention.

In another embodiment, an open pore membrane can be used in the support and can be formed in accordance with the known technique of phase inversion. Examples of a porous layer comprising an open-pore membrane, for use in a support, are disclosed in U.S. Pat. No. 6,497,941 and U.S. Pat. No. 6,503,607 both by Landry-Coltrain et al., hereby incorporated by reference.

In still another embodiment, a porous support can comprise poly(lactic acid), for example, as disclosed in copending commonly assigned U.S. Ser. No. 10/722,886 filed Nov. 26, 2003 by Thomas M. Laney et al., titled “Inkjet Recording Element and Method of Use,” hereby incorporated by reference in its entirety. In this embodiment, a microvoided polylactic-acid-containing layer can have levels of voiding, thickness, and smoothness adjusted to provide desired absorbency or other properties. The polylactic acid-containing layer can advantageously also provide stiffness to the media and physical integrity to other layers. The thickness of the microvoided polylactic acid layer can be 30 to 400 μm depending on the required stiffness of the recording element. Typically, a thickness of at least about 28.0 μm is needed to achieve a total absorbency of 10 ml/m² if desired for use as a carrier liquid retaining layer.

Other materials useful for making the support include, but are not limited to, microporous polymeric films filled with porous usually inorganic particles, nanofibers and/or microfibers, foamed films, and/or combinations thereof.

In particular, one embodiment involves an inkjet recording element in which the support comprises microfibers and/or nanofibers, which are fine fibers that can be made into a non-woven fine-fiber layer. A variety of materials can be used, including a wide range of polymeric compositions including polyolefins such as Tyvek® polyolefin (DuPont, Wilmington, Del.).

In still another embodiment, the porous support can comprise a foamed film, for example, comprising a foamed polyethylene material. See, for example, U.S. Pat. Nos. 5,869,544; 5,677,355; and 6,353,037; relating to examples of various techniques for open-cell foaming, which patents are hereby incorporated by reference in their entirety.

In yet another embodiment, the porous support comprises a microporous material made from polymeric films filled with porous, usually inorganic particles. For example, U.S. Pat. No. 5,605,750, hereby incorporated by reference, describes a microporous material that comprises siliceous filler particles distributed throughout a matrix of a thermoplastic organic polymer, for example, a polyolefin such as polyethylene or polypropylene. Similar materials are described in U.S. Pat. No. 6,025,068 to Pekala, in which the organic polymer comprises a poly(ethylene oxide) and a crosslinkable urethane-acrylic hybrid polymer; and in U.S. Pat. No. 5,326,391 to Anderson et al., in which the organic material comprises essentially linear ultrahigh molecular weight olefin such as polyethylene filled with silica particles, both patents hereby incorporated by reference in their entirety.

The porous support, as mentioned above, contains interconnecting voids. These voids provide a pathway for an ink carrier fluid or liquids in the ink composition to penetrate to some extent into the substrate, thus allowing the porous support with interconnecting voids to contribute to the dry time. A non-porous support that contains closed cells will not allow the support to contribute to the dry time.

If a porous support is employed it may be advantageous, for fluid transport reasons, but not necessary, for the support to have a pore size smaller than that of the ink-receptive layer. For example, a permeable microvoided or otherwise porous support contains voids that are interconnected or open-celled in structure and can enhance the liquid carrier absorption rate by enabling capillary action to occur. Maintaining the correct pore size hierarchy can afford access to the pore capacity of the support and eliminate capacity related bleed. Capacity related bleed occurs when insufficient void volume is available to accommodate the ink, resulting in unwanted lateral spreading of the colorant.

The thickness of the support employed in the invention can be from about 12 to about 500 μm, preferably from about 75 to about 300 μm.

If desired, in order to improve the adhesion to the support of the fusible, porous ink-receptive layer, the surface of the support may optionally be corona-discharge-treated prior to applying the ink-receptive layer to the support.

Since the image recording element may come in contact with other image recording articles or the drive or transport mechanisms of image recording devices, additives such as surfactants, lubricants, matte particles, and the like may be added to the element to the extent that they do not degrade the properties of interest.

The ink-receptive layer may be coated by conventional coating means onto a support material commonly used in this art. Coating methods may include, but are not limited to, wound wire rod coating, slot coating, slide hopper coating, gravure, curtain coating, air knife coating, and the like. Some of these methods allow for simultaneous coatings of all three layers, which is preferred from a manufacturing economic perspective.

After printing on the element of the invention, the fusible, porous ink-receptive layer is heat and/or pressure fused to form a substantially continuous layer on the surface. Upon fusing, the layer is rendered non-light scattering. Fusing may be accomplished in any manner which is effective for the intended purpose. A description of a fusing method employing a fusing belt can be found in U.S. Pat. No. 5,258,256, and a description of a fusing method employing a fusing roller can be found in U.S. Pat. No. 4,913,991, the disclosures of which are hereby incorporated by reference.

In a preferred embodiment, fusing is accomplished by contacting the surface of the element with a heat-fusing member, such as a fusing roller or fusing belt. Thus, for example, fusing can be accomplished by passing the element through a pair of heated rollers, heated to a temperature of about 60° C. to about 160° C., using a pressure of about 0.4 to about 0.7 MPa at a transport rate of about 0.005 m/sec to about 0.5 m/sec.

Inkjet inks used to image the recording elements of the present invention are well known in the art. The ink compositions used in inkjet printing typically are liquid compositions comprising a solvent or carrier liquid, colorants such as dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946; 4,239,543; and 4,781,758, the disclosures of which are hereby incorporated by reference.

In another embodiment of the invention the fusible, porous layer comprises at least two types of hydrophobic polymer particles having different glass transition temperatures, the first type of hydrophobic polymer particles having a Tg higher than about 60° C. that is substantially monodispersed. In the preferred embodiment, the first type of hydrophobic polymer particles, which are substantially monodispersed, can be prepared, for example, by emulsion polymerization of ethylenically unsaturated monomers with or without surfactants. Any suitable ethylenically unsaturated monomer or mixture of monomers may be used in making monodisperse polymer particles. There may be used, for example, ethylene, propylene,1-butene, butadiene, styrene, α-methylstyrene, vinyltoluene, t-butylstyrene; mono-ethylenic unsaturated esters of fatty acids (such as vinyl acetate, allyl acetate, vinyl stearate, vinyl pivalate); monoethylenic unsaturated amides of fatty acids (such as N-vinylacetamide, N-vinylpyrrolidone); ethylenic unsaturated mono-carboxylic acid or dicarboxylic acid esters(such as methyl acrylate, ethyl acrylate, propylacrylate, 2-chloroethylacrylate, 2-cyanoethylacrylate, hydroxyethyl acrylate, methyl methacrylate, n-butyl methacrylate, benzyl acrylate, 2-ethylhexyl acrylate, cyclohexyl methacrylate, tetrahydrofurfuryl acrylate, tetrahydrofurfuryl methacrylate, isobomylacrylate, isobomylmethacrylate, n-octyl acrylate, diethyl maleate, diethyl itaconate); ethylenic unsaturated monocarboxylic acid amides (such as acrylamide, t-butylacrylamide, isobutylacrylamide, n-propylacryamide, dimethylacrylamide, methacrylamide, diacetoneacrylamide, acryloylmorpholine); and mixtures thereof. Up to 5% by weight based on total monomer mixture of water-soluble monomers can also be copolymerized to improve particles stability. Examples of preferred water-soluble comonomers are ethylenic unsaturated salts of sulfonate or sulfate (such as sodium acrylamide-2-methylpropane-sulfonate, sodium vinylbenzenesulfonate, potassium vinylbenzylsulfonate, sodium vinylsulfonate); mono-ethylenic unsaturated compounds (such as acrylonitrile, methacrylonitrile), and mono-ethylenic unsaturated carboxylic acid (such as acrylic acid, methacrylic acid, itaconic acid, maleic acid). If desired, monomers containing a UV absorbing moiety, antioxidant moiety or crosslinking moiety may be used in forming the monodisperse polymer particles in order to improve light fastness of the image or other performance.

Typical crosslinking monomers which can be used in forming the monodisperse polymer particles include aromatic divinyl compounds such as divinylbenzene, divinylnaphthalene, or derivatives thereof; diethylene carboxylate esters and amides such as ethylene glycol dimethacrylate, diethylene glycol diacrylate, and other divinyl compounds such as divinyl sulfide or divinyl sulfone compounds. Divinylbenzene and ethylene glycol dimethacrylate are especially preferred.

Examples of a monodisperse polymer particle preparation can be found in “Emulsion Polymerization and Emulsion Polymers,” P. A. Lovell and M. S. El-Aasser, John Wiley & Sons, Ltd., 1997, and U.S. Pat. No. 4,415,700, the disclosures of which are hereby incorporated by reference.

The monodisperse polymer particles used in the fusible porous ink-receptive layer of this invention are preferably non-porous. By non-porous is meant a particle that is either void-free or not permeable to liquids. These particles can have either a smooth or a rough surface.

The second type of hydrophobic polymer having a Tg of less than 25° C. can be a latex or a hydrophobic polymer of any composition that can be stabilized in a water-based medium. This acts as a binder for the fusible polymeric particles.

Other polymeric binders that may be used in the ink-receptive layer of the invention can include, for example, hydrophilic polymers such as poly(vinyl alcohol), polyvinyl acetate, polyvinyl pyrrolidone, gelatin, poly(2-ethyl-2-oxazoline), poly(2-methyl-2-oxazoline), poly( acrylamide), chitosan, methylcellulose, ethyl cellulose, hydroxyethyl cellulose, hydroxypropyl cellulose, etc. Other binders can also be used such as hydrophobic materials such as poly(styrene-co-butadiene), a polyurethane latex, a polyester latex, acrylic latices such as poly(n-butyl acrylate), poly(n-butyl methacrylate), poly(2-ethylhexyl acrylate), a copolymer of n-butylacrylate and ethylacrylate, a copolymer of vinylacetate and n-butylacrylate, and the like.

The image-receiving layer may also contain additives such as pH-modifiers, rheology modifiers, surfactants, UV-absorbers, biocides, lubricants, waxes, dyes, optical brighteners, etc.

Another aspect of the present invention relates to an inkjet printing method, comprising the steps of:
A) providing an inkjet printer that is responsive to digital data signals;
B) loading the printer with the inkjet recording element, as described above, comprising a fusible, porous, image-receiving layer;
C) loading the printer with an inkjet ink;
D) printing on the inkjet recording element using the inkjet ink in response to the digital data signals; and
E) fusing the fusible, porous image-receiving layer.

Preferably, the method comprises the use of pigmented inkjet inks and preferably, the pigmented inks are such that they are retained in the image-receiving layer after being applied to the element.

Although the recording elements disclosed herein have been referred to primarily as being useful for inkjet printers, they also can be used as recording media for pen plotter assemblies. Pen plotters operate by writing directly on the surface of a recording medium using a pen consisting of a bundle of capillary tubes in contact with an ink reservoir.

During the inkjet printing process, ink droplets are rapidly absorbed into the porous layer through capillary action and the image is dry-to-touch right after it comes out of the printer. Therefore, porous layer allows a fast “drying” of the ink and produce a smear-resistant image.

The following examples are provided to illustrate the invention.

### EXAMPLES

Substrates Tested:

The following substrates were used in creating inkjet receiving samples:
Substrate 1 of the Invention: 65# Quantum® Smooth cover paper (Domtar Inc.) is a porous, cellulosic fiber substrate with interconnecting voids.
Substrate 2 of the Invention: 10 mil Teslin® SP Synthetic Printing Sheet (PPG Industries Inc.) is a porous substrate with interconnecting voids comprised of polyethylene and silica.
Substrate 3 of the Invention: Tyvek® spunbonded, non-woven synthetic sheet (E.I. DU PONT DE NEMOURS and COMPANY) is a porous substrate with interconnecting voids comprised of polyethylene.
Substrate 4 of the Invention: 171 g/m² photographic paper (Eastman Kodak Company) is a porous, cellulosic fiber substrate with interconnecting voids. In comparison to Substrate 1, this substrate has relatively more sizing, resulting in a more hydrophobic paper that holds more water out.

Substrate 5 of the Invention: An ink-permeable polyester film made as follows: A three-layered polyester substrate comprising an impermeable core polyester layer and an ink-permeable upper and lower polyester layer was prepared using 1) a poly(ethylene terephthalate)(PET) resin (IV=0.70 dl/g) for the core layer; 2) a compounded blend for the top and bottom layers consisting of 29% by weight of an amorphous polyester resin, PETG 6763 resin (IV=0.73 dl/g)(Eastman Chemical Company), 29% by weight poly(ethylene terephthalate)(PET) resin (IV=0.70 dl/g), and 42% by weight of cross-linked poly(methylmethacrylate)(PMMA) particles approximately 1.7 um in size.

The cross-linked PMMA particles were compounded with the PETG 6763 and the PET resins through mixing in a counter-rotating twin screw extruder attached to a pelletizing die. The extrudate was passed through a water bath and pelletized.

The two resins for the three layers were dried at 65° C. and fed by two plasticating screw extruders into a coextrusion die manifold to produce a three-layered melt stream which was rapidly quenched on a chill roll after issuing from the die. By regulating the throughputs of the extruders, it was possible to adjust the thickness ratio of the layers in the cast laminate sheet. In this case, the thickness ratio of the three layers was adjusted at 1:6:1 with the thickness of the two outside layers being approximately 250 μm. The cast sheet was first oriented in the machine direction by stretching at a ratio of 3.3 and a temperature of 110° C.

The oriented substrate was then stretched in the transverse direction in a tenter frame at a ratio of 3.3 and a temperature of 100° C. In this example, no heat setting treatment was applied. The final total film thickness was 200 μm, with the permeable top and bottom layers being 50 μm each, and the layers within the substrate were fully integrated and strongly bonded. The stretching of the heterogeneous top and bottom layers created interconnected microvoids around the hard cross-linked PMMA beads, thus rendering this layer opaque (white) and highly porous and permeable. The PET core layer, however, was impermeable and retained its natural clarity.

Control Substrate 1: Photographic paper substrate (Eastman Kodak Company) is a cellulosic paper core with a non-porous polyethylene layer coated on either side of the paper core.

All substrates were evaluated for ink absorption and practical inkjet printing drytime. For ink absorption, the Bristow test method, outlined completely in ASTM test method D 5455, was used. 50 microliters of Encad® GX magenta ink (commercially available from Eastman Kodak Company, Rochester, N.Y.) was measured into the application hopper. Bristow ink absorption values were made at a wheel rotational speed of 1.25 mm/s and are shown in Table 1.

For practical inkjet printing drytime measurements, images were printed on the substrates using both Epson® 870 dye-based and Epson® 2200 pigment-based inkjet desktop printers. The Epson® 870 printer used black cartridge T007 201 and color cartridge T008 201. The Epson® 2200 printer used cyan cartridge T0342 20, light cyan cartridge T0345 20, magenta cartridge T0343 20, light magenta cartridge T0346 20, yellow cartridge T0344 20, photo black cartridge T0341 20, and light black cartridge T0347 20. The images contained 100% ink coverage blocks of cyan, magenta, yellow, red, green, blue, and black adjacent to each other for drytime measurements. These blocks were approximately 1 cm by 1.5 cm in size.

For drytime evaluation, the printed images were set on a flat surface immediately after ejection from the printer. The seven adjacent color blocks were then wiped with the index finger under normal pressure in one pass. The index finger was covered with a rubber finger cot. The drytime was rated as 1 when no smearing was observed. The drytime was rated as 5 if all colors severely smeared. Intermediate drytimes were rated between 1 and 5. The drytime results are shown in Table 1.

TABLE 1

| | Bristow Test | | |
|---|---|---|---|
| | Absorption | EPSON 870 | EPSON 2200 |
| | (ml/m²) | Drytime | Drytime |
| Substrate 1 of the | 94.2 | 1 | 1 |
| Invention | | | |
| Substrate 2 of the | 28.5 | 1 | 1 |
| Invention | | | |
| Substrate 3 of the | 57.6 | 1 | 1.5 |
| Invention | | | |
| Substrate 4 of the | 6.2 | 1 | 1.5 |
| Invention | | | |
| Substrate 5 of the | 23.6 | 1 | 1 |
| Invention | | | |
| Control Substrate 1 | 1.4 | 5 | 5 |

It is clear from the results in Table 1 that substrates with a Bristow Absorption value of 3 ml/m² or greater have enough pore volume to contain the printed inks and provide good drytimes. Values of 2 or less are considered acceptable for drytime.

Fusible Porous Ink Receiving Layer Composition

HS 3000NA Modified Hollow Sphere Plastic Pigments (Dow Chemical Company): 8.5 parts

Witcobond® W-320 polyurethane dispersion (CK Witco Corporation): 1.5 parts

Water: 90 parts

HS 3000NA Modified Hollow Sphere Plastic Pigments are hollow styrene acrylic particles of approximately 1 micron in diameter that provide a porous ink receiving layer when coated on a substrate to accept the printed inks. After printing, gloss and durability to the image can be obtained by heat fusing the ink receiving layer. The Witcobond® W-320 is a nonionic polyurethane dispersion that was used to bind the HS 3000NA plastic pigments together in the ink receiving layer. The average particle size of the polyurethane dispersion was 3 microns and the Tg was −12° C., both quoted from CK Witco Corporation. To make up the ink-receptive layer, the HS 3000NA plastic pigments were first added to water followed by addition of the Witcobond® W-320. The mixture was then stirred for 1 hour.

Preparation of Fusible Inkjet Receiving Element 1 of the Invention

Substrate 1 of the Invention was coated with the above described fusible, porous ink-receiving layer composition using a rod coater to make inkjet receivers with dry receiver layer thicknesses of approximately 7.5, 15, 22.5 and 30 micrometers. The coatings were allowed to air dry for 18 hours before printing.

Element 2 of the Invention

This element was prepared the same as Element 1 except that it used Substrate 2 of the Invention.

Element 3 of the Invention

This element was prepared the same as Element 1 except that it used Substrate 3 of the Invention.

Element 4 of the Invention

This element was prepared the same as Element 1 except that it used Substrate 4 of the Invention.

Element 5 of the Invention

This element was prepared the same as Element 1 except that is used Substrate 5 of the Invention.

Control Element 1

This element was prepared the same as Element 1 except that it used Control Substrate 1.

All elements were printed and evaluated for drytime in the same manner as described previously. Also, ink-absorption measurements were made using the Bristow test procedure previously described. Drytime and Bristow Test ink absorption results are given in Table 2.

TABLE 2

| | Approximate | | | |
|---|---|---|---|---|
| | Ink Receiving | Bristow | EPSON | EPSON |
| | Layer Thickness | Absorption | 870 | 2200 |
| | (microns) | (ml/m²) | Drytime | Drytime |
| Element 1 | 7.5 | 24.9 | 1.5 | 1.5 |
| Element 1 | 15 | 33.3 | 1.5 | 1 |
| Element 1 | 22.5 | 41.4 | 1 | 1 |
| Element 1 | 30 | 44.9 | 1 | 1 |
| Element 2 | 7.5 | 28.8 | 1 | 1 |
| Element 2 | 15 | 27.5 | 1 | 1 |
| Element 2 | 22.5 | 28.4 | 1 | 1 |
| Element 2 | 30 | 32.5 | 1 | 1 |
| Element 3 | 7.5 | 33.1 | 1.5 | 1.5 |
| Element 3 | 15 | 28.1 | 1.5 | 1 |
| Element 3 | 22.5 | 32.1 | 1 | 1 |
| Element 3 | 30 | 40.2 | 1 | 1 |
| Element 4 | 7.5 | 14.5 | 1 | 1 |
| Element 4 | 15 | 24.9 | 1 | 1 |
| Element 4 | 22.5 | 30.8 | 1 | 1 |
| Element 4 | 30 | 42.2 | 1 | 1 |
| Element 5 | 7.5 | 18.9 | 1 | 1 |
| Element 5 | 15 | 28.5 | 1 | 1 |
| Element 5 | 22.5 | 36.4 | 1.5 | 1 |
| Element 5 | 30 | 37.5 | 1 | 1 |
| Control Element 1 | 7.5 | 8.2 | 5 | 3 |
| Control Element 1 | 15 | 20.4 | 2 | 1 |
| Control Element 1 | 22.5 | 31.0 | 1 | 1 |
| Control Element 1 | 30 | 39.6 | 1 | 1 |

Table 2 shows that good, printed drytime results with images printed with both dye-based and pigment-based inks and can be achieved if the substrate has a Bristow absorption value of at least 3 ml/m² and the inkjet receiving element comprising the substrate and fusible, porous ink-receiving layer has a Bristow absorption of at least 10 m/m².

Although the invention has been described in detail with reference to certain preferred embodiments for the purpose of illustration, it is to be understood that variations and modifications can be made by those skilled in the art without departing from the spirit and scope of the invention.

1. An inkjet recording element having a porous ink-receptive layer comprising fusible polymeric particles and an upper and lower surface, wherein the lower surface of the ink-receptive layer is contiguous with a porous support, and wherein the porous support comprises interconnecting open-cell pores facing the lower surface of the porous ink-receptive layer, which pores are, therefore, capable of receiving a substantial amount of ink-carrier liquid from an inkjet composition applied to the fusible, porous ink-receptive layer.

2. The element of claim 1 wherein the fusible, porous ink-receptive layer is the only layer above the porous support and is capable of holding substantially all ink colorant in the inkjet composition that is applied to the inkjet recording element.

3. The element of claim 1 wherein the porous support has a Bristow Test absorption value of at least 3 ml/m².

4. The element of claim 1 wherein the porous support and the fusible, porous ink-receptive layer in combination has a Bristow Test absorption value of at least 10 ml/m².

5. The element of claim 1 wherein the porous support comprises an open-cell voided polymeric film contiguous with the lower surface of the ink-receptive layer.

6. The element of claim 1 wherein the porous support comprises a cellulosic paper contiguous with the lower surface of the ink-receptive layer.

7. The element of claim 1 wherein the porous support comprises a synthetic non-woven fibrous sheet contiguous with the lower surface of the ink-receptive layer.

8. The element of claim 1 wherein the porous support comprises a foamed film optionally overlying a support, which foamed film is contiguous with the lower surface of the ink-receptive layer.

9. The element of claim 1 wherein the porous support comprises a polyolefin binder and siliceous particles, forming a porous layer contiguous with the lower surface of the ink-receptive layer.

10. The element of claim 1 wherein the porous support comprises cellulosic paper having a lower surface that is resin coated with a polyethylene film, wherein an uncoated upper surface of the paper is contiguous with the lower surface of the ink-receptive layer.

11. The element of claim 1 wherein the porous support comprises a voided poly(lactic acid) or polyester material that is contiguous with the lower surface of the ink-receptive layer.

12. The element of claim 1 wherein the fusible polymeric particles in the fusible, porous ink-receptive layer comprise a condensation polymer, a styrenic polymer, a vinyl polymer, an ethylene-vinyl chloride copolymer, a polyacrylate, poly(vinyl acetate), poly(vinylidene chloride), a vinyl acetate-vinyl chloride copolymer, a polyester, a polyurethane, or an acid ester of cellulose.

13. The element of claim 1 wherein the fusible polymeric particles in the fusible, porous ink-receptive layer comprise a copolymer of ethyl methacrylate and methyl methacrylate.

14. The element of claim 1 wherein the fusible, porous ink-receptive layer comprises a binder.

15. The element of claim 14 wherein the binder in the fusible, porous ink-receptive layer comprises a swellable hydrophilic polymer, an aqueous dispersion of an acrylic polymer or polyurethane, or beads of a low Tg polymer.

16. The element of claim 1 wherein the fusible polymeric particles in the fusible, porous ink-receptive layer are cationic.

17. The element of claim 1 wherein the fusible, porous ink-receptive layer comprises a mordant.

18. The element of claim 17 wherein the mordant comprises a cationic latex.

19. The element of claim 1 wherein the fusible polymeric particles in the fusible, porous ink-receptive layer range in size, average diameter, from about 0.5 to about 10 μM.

20. The element of claim 14 wherein the particle-to-binder ratio of the fusible polymeric particles and the binder in the ink-receptive layer is between about 95:5 and 60:40.

21. An inkjet recording element comprising:
a) a fusible, porous ink-receptive layer comprising fusible polymeric particles; and
b) a porous support;
wherein the porous support and the ink-receptive layer in combination exhibits a Bristow Test absorption value of least 10 ml/m² and wherein the porous support has a Bristow Test absorption value of at least 3 ml/m².

22. An inkjet printing process, comprising the steps of:
A) providing an inkjet printer that is responsive to digital data signals;
B) loading the inkjet printer with the inkjet recording element of claim 1, the inkjet recording element comprising a fusible, porous ink-receptive layer;
C) loading the inkjet printer with an inkjet ink composition;
D) printing on the inkjet recording element using the inkjet ink composition in response to the digital data signals; and
E) fusing the fusible, porous ink-receptive layer.

23. The inkjet printing process of claim 22 wherein the fusible, porous ink-receptive layer and/or the porous support, in combination, is capable of receiving substantially all in-carrier liquid in the inkjet ink composition received by the inkjet recording element.

24. The inkjet printing process of claim 22 wherein the inkjet ink compositions comprise pigmented ink.

25. The inkjet printing process of claim 22 wherein the fusible, porous ink-receptive layer is capable of holding substantially all ink colorant in the inkjet ink composition that is applied to the inkjet recording element.
